(19) United States
(12) Patent Application Publication
(10) Pub. No.: US 2016/0062099 A1
(43) Pub. Date: Mar. 3, 2016

(54) IMAGE COLLECTION THROUGH A MICROSCOPE AND AN ADAPTOR FOR USE THEREWITH

(71) Applicant: Syntheslide, LLC, Royal Oak, MI (US)

(72) Inventors: Nakul Shankar, Midland, MI (US); Austin McCarty, Sterling Heights, MI (US)

(21) Appl. No.: 14/836,683

(22) Filed: Aug. 26, 2015

Related U.S. Application Data
(60) Provisional application No. 62/042,683, filed on Aug. 27, 2014.

(51) Int. Cl. G02B 21/24

(52) U.S. Cl. CPC G02B 21/24

(57) ABSTRACT

Embodiments of the present invention are related to image collection through a microscope and an adaptor for use therewith. In an embodiment, an adaptor for coupling a camera device to a microscope comprises: a platform for releasably receiving a camera device, wherein the platform comprises a hole that can align with a lens of the camera device and a barrel of the microscope; and a clasp portion for removably coupling the adaptor to the barrel of the microscope.

### CROSS REFERENCE TO RELATED APPLICATIONS

The present application claims the benefit of and priority to, under 35 U.S.C. § 119(e), U.S. Provisional Application Ser. No. 62/042,683, filed Aug. 27, 2014, entitled IMAGE COLLECTION THROUGH A MICROSCOPE, which is hereby incorporated herein by reference in its entirety for all that they teach and for all purposes.

### TECHNICAL FIELD

This invention concerns image collection through a microscope. In particular, this invention concerns image collection using a mobile device that is coupled to a microscope via an adaptor.

### SUMMARY

Taking images of samples, as viewed through an eyepiece of a microscope, can provide useful images for a researcher. For example, images of different samples taken at different labs can be compared with one another to determine variations in the samples. As another example, images taken at different times of the same sample can be compared with one another to determine the evolution of the sample. Additionally, when taking images of samples, positioning the lens of the camera in the same position can be useful for the researcher. The embodiments provided herein offer an apparatus that can be useful in

In Example 1, an adaptor for coupling a camera device to a microscope, the adaptor comprising: a platform for releasably receiving a camera device, wherein the platform comprises a hole that can align with a lens of the camera device and a barrel of the microscope; and a clasp portion for removably coupling the adaptor to the barrel of the microscope.

In Example 2, the adaptor according to Example 1, wherein the adaptor further comprises an attachment structure that can releasably attach the camera device to the platform.

In Example 3, the adaptor according to Example 2, wherein the attachment structure is at least one of the following: a clasp, a clamp and an elastic band.

In Example 4, the adaptor according to any of Examples 1-3, further comprising an adjustment mechanism operable to move the camera device relative to the hole and to a position where a camera lens of the camera device is aligned with the hole of the platform.

In Example 5, the adaptor according to Example 4, wherein the adjustment mechanism comprises: a first adjustment mechanism that can slide along a first axis relative to the hole and engage a first side of the camera device to position the camera device at a position along the first axis; and a second adjustment mechanism that can slide along a second axis relative to the hole and engage a second side of the camera device to position the camera device at a position along the second axis, the second axis being substantially perpendicular to the first axis.

In Example 6, the adaptor according to Example 5, wherein the first adjustment mechanism comprises a first structure that can secure the first adjustment mechanism at a position along the first axis and the second adjustment mechanism comprises a second structure that can secure the second adjustment mechanism at a position along the second axis.

In Example 7, the adaptor according to Example 6, wherein the first structure and the second structure are at least one of the following: a knob and a clamp.

In Example 8, the adaptor according to any one of Examples 1-7, wherein the clasp portion comprises: a first right arm and a first left arm that clasp onto the barrel of the microscope.

In Example 9, the adaptor according to Example 8, wherein the first right arm comprises a rubber material at a point of contact between the first right arm and the barrel of the microscope and wherein the first left arm comprises a rubber material at a point of contact between the first left arm and the barrel of the microscope.

In Example 10, the adaptor according to any one of Examples 8 or 9, further comprising a biasing structure coupled to the first right arm and the first left arm that provides a force that biases the first right arm and the first left arm toward each other.

In Example 11, the adaptor according to Example 10, wherein the biasing structure is a spring.

In Example 12, the adaptor according to any one of Examples 8-11, wherein the clasp portion further comprises: a second right arm, a second left arm and a spring mechanism located between the second right arm to the second left arm, the spring mechanism providing a force that biases the second right and the second left arm away from each other, which biases the first right arm and the first left arm toward each other.

In Example 13, the adaptor according to any one of Examples 1-12, further comprising: a coupling structure, wherein the coupling structure couples the platform to the clasp, wherein the platform can rotate about the coupling structure to align the hole with the barrel of the microscope.

In Example 14, the adaptor according to Example 13, wherein the coupling structure is an adjustment knob.

In Example 15, the adaptor according to any one of Examples 1-14, wherein the platform is generally planar.

In Example 16, the adaptor according to any one of Examples 1-15, further comprising a flange projecting from a bottomside of the platform for aligning the hole of the platform with the barrel of the microscope.

In Example 17, method for operating an adaptor for coupling a camera device to a microscope, the method comprising: placing a camera device on an adaptor, wherein the adaptor comprises a platform for releasably receiving the camera and a clasp portion, wherein the platform comprises a hole that can align with a lens of the camera device and a barrel of the microscope; and releasably mounting the adaptor to the barrel of the microscope such that the hole of the platform is substantially aligned with the barrel of the microscope.

In Example 18, the method according to Example 17, wherein the adaptor further comprises an attaching structure for releasably attaching the camera device to the platform and wherein placing the camera device on the adaptor comprises attaching the camera device to the platform using the attaching structure.

In Example 19, the method according to any one of Examples 17or 18, wherein the attaching structure is an elastic band that has a proximal end coupled to a first side of the platform and wherein attaching the camera device to the platform using the elastic band comprises stretching the elastic band over the camera device and coupling a distal end of the elastic band to a second side of the platform, the second side of the platform being opposite the first side of the platform.

In Example 20, the method according to any one of Examples 17-19, wherein the adaptor further comprises an adjustment mechanism operable to move the camera device relative to the hole, the method further comprising: moving the adjustment mechanism to a position that engages the camera and a camera lens of the camera device is aligned with the hole of the platform.

In Example 21, the method according to Example 20, wherein the adjustment mechanism comprises a first adjustment mechanism that can slide along a first axis relative to the clasp portion and engage a first side of the camera device and a second adjustment mechanism that can slide along a second axis relative to the clasp portion and engage a second side of the camera device, the second axis being substantially perpendicular to the first axis and wherein moving the adjustment mechanism comprises: sliding the first adjustment mechanism along the first axis such that the first adjustment mechanism engages the first side of the camera device at a first position, wherein a camera lens of the camera device is aligned with the hole along the first axis when the first side of the camera device is at the first position; and sliding the second adjustment mechanism along the second axis such that the second adjustment mechanism engages the second side of the camera device at a second position, wherein a camera lens of the camera device is aligned with the hole along the second axis when the second side of the camera device is at the second position.

In Example 22, the method according to Example 21, wherein the first adjustment mechanism comprises a first structure that secures the first adjustment mechanism at a position along the first axis and the second adjustment mechanism comprises a second structure that secures the second adjustment mechanism at a position along the second axis, the method further comprising: securing the first adjustment mechanism, using the first structure, at the first position; and securing the second adjustment mechanism, using the second structure, at the second position.

In Example 23, the method according to any one of Examples 17-22, wherein the adaptor further comprises a coupling structure that couples the platform to the clasp, wherein the platform can rotate about the coupling structure to align the hole with the barrel of the microscope and wherein releasably mounting the adaptor to the barrel of the microscope comprises: rotating the platform about the coupling structure to align the hole of the platform with the barrel of the microscope.

In Example 24, the method according to any one of Examples 17-23, further comprising: taking a first image, using the camera device, of a section of a sample as viewed through the barrel of the microscope at a first time; and taking a second image, using the camera device, of the section of the sample as viewed through the barrel of the microscope at a second time.

In Example 25, an adaptor for coupling a camera device to a microscope, the adaptor comprising: a platform comprising: a generally planar surface in an X-Y plane, a top side of the generally planar surface configured to receive the camera device, and an aperture in the generally planar surface, the aperture configured to allow light to pass through the aperture and be received by a camera lens of the camera; and a clasp portion coupled to a bottom side of the platform for removably coupling the adaptor to a barrel of the microscope.

In Example 26, the adaptor according to Example 25, further comprising: a first adjustment mechanism configured to slide along an axis in the X direction and engage a first side of the camera device to position the camera device at a first position along the X axis; and a second adjustment mechanism configured to slide along an axis in the Y direction and engage a second side of the camera device to position the camera device at a second position along the Y axis.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of a camera and an adaptor for coupling the camera device to a microscope, in accordance with the embodiments of the present disclosure.

FIG. 2 is a side view of a camera and of an adaptor for coupling the camera device to a microscope, in accordance with the embodiments of the present disclosure.

FIG. 3 is a bottom perspective view of a camera device and an adaptor for coupling the camera device to a microscope, in accordance with the embodiment of the present disclosure.

FIG. 4 is a perspective view of an adaptor for coupling a camera device to a microscope, in accordance with the embodiments of the present invention.

FIG. 5 is a side view of a system for coupling a camera device to a microscope, in accordance with the embodiments of the present disclosure.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

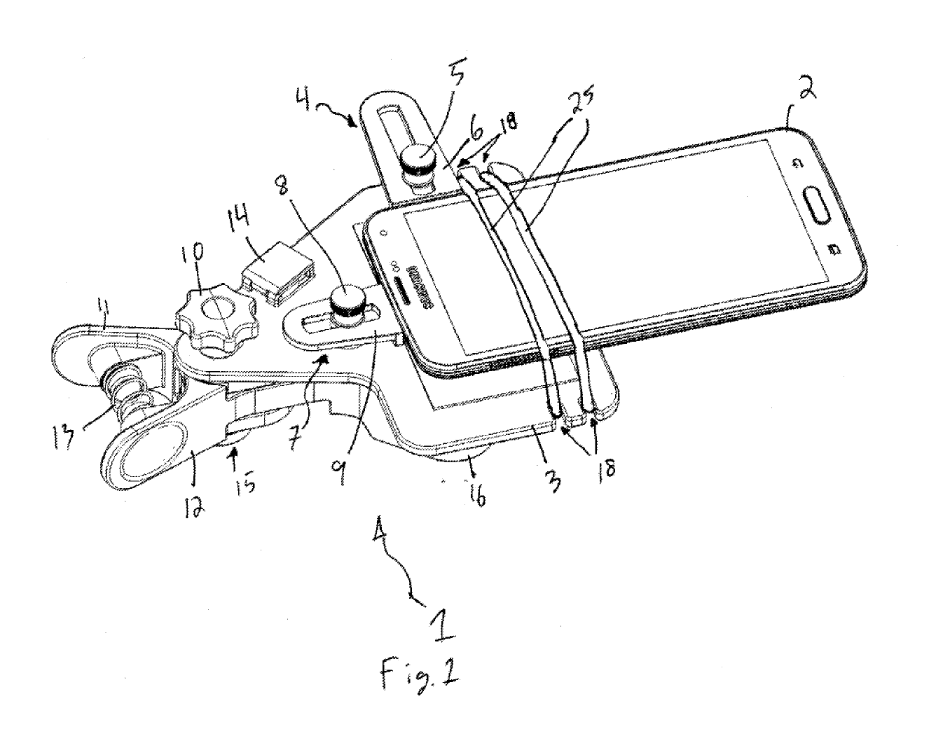

FIG. 1 illustrates an adapter 1. A camera device 2 is mounted on a platform 3 of the adapter 1. The platform 3 is generally planar. The platform 3 includes lateral notches 18. An elastic band 25 is wound around the lateral notches 18 and over the topside of the platform 3 and over the top side of the camera device 2 to hold the camera device 2 against the platform 3. Alternatively, holes can be provided in the platform 3 in the approximate location of the lateral notches 18.

The camera device 2 may be positioned on the platform 3 by a lateral adjustment mechanism 4 and a distal-proximal adjustment mechanism 7. The lateral adjustment mechanism 4 comprises a lateral bracket 6. Additionally, in embodiments, the lateral adjustment mechanism 4 comprises a tightening knob 5. In embodiments, a clamp can be substituted for the tightening knob 5. As shown, the lateral bracket 6 includes a slot in which a lower portion of the knob 5 can slide. The lateral bracket 6 slides laterally to engage the camera device 2 to position the camera device 2 along the lateral axis. The distal-proximal adjustment mechanism 7 comprises a distal-proximal bracket 9. Additionally, in embodiments, the distal-proximal adjustment mechanism 7 comprises a tightening knob 8. In embodiments, a clamp can be substituted for the tightening knob 8. As shown, the distal-proximal bracket 9 includes a slot in which a lower portion of the knob 8 can slide. The distal-proximal bracket 9 slides in a distal direction as well as in a proximal direction to engage the camera device 2 to position the camera device 2 along the distal-proximal axis.

In embodiments, a housing 14 is positioned on the adapter 1. As shown, the housing 14 is located on the topside of the platform 3. The housing 14 includes a top portion that is attached by a hinge to a lower portion of the housing 14. The top portion of the housing 14 opens in a clamshell manner relative to the lower portion of the housing 14 to reveal any interior cavity. In embodiments, the housing 14 can be used to carry a calibration grid to quantify unique distortion characteristics of the lenses in use. In embodiments, slides can conveniently be housed within the housing 14.

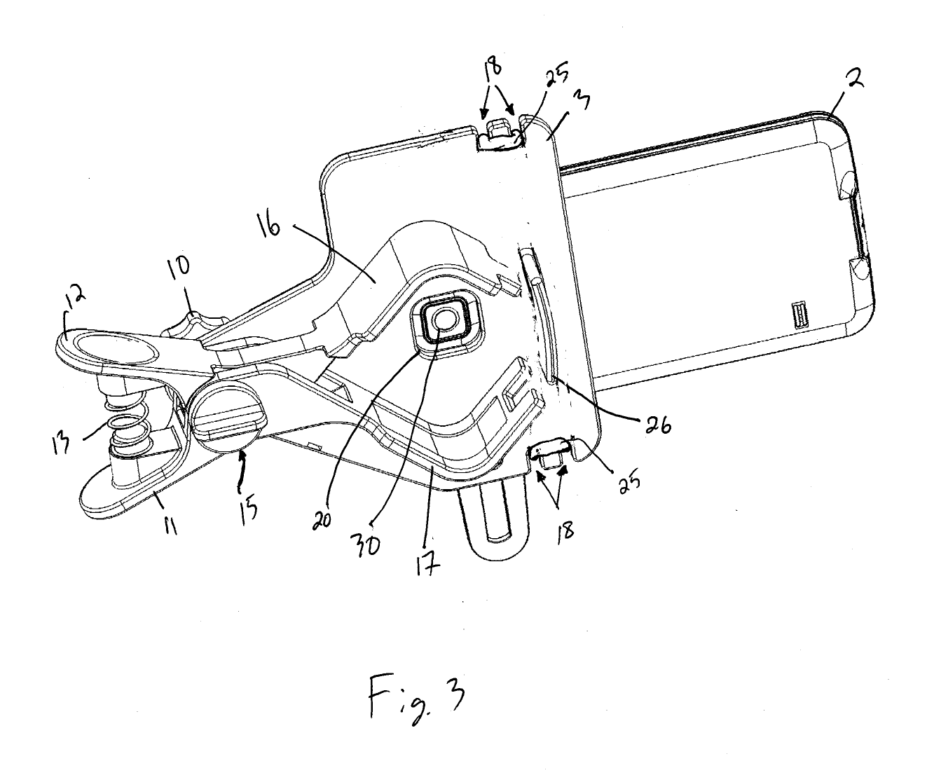

In embodiments, the adapter 1 further includes a vertical adjustment knob 10. The vertical adjustment knob 10 may, in part, couple the platform 3 of the adapter 1 to a lower clasp portion 15 of the adaptor 1. The lower clasp portion 15 includes a left proximal arm 11, a right proximal arm 12, a right distal arm 16, and a left distal arm 17, as shown in FIG. 3. The lower clasp portion 15 is kept in tension by the spring 13 which engages the left proximal arm 11 and the right proximal arm 12. That is, the spring 13 engages the left proximal arm 11 and the right proximal arm 12 and biases the left proximal arm 11 in a direction away from the right proximal arm 12, and vice-versa. Due to the spring 13 biasing the left proximal arm 11 in a direction away from the right proximal arm 12, the right distal arm 16 is biased in a direction towards the left distal arm 17, and vice-versa. The vertical adjustment knob 10 can be loosened or tightened to increase the frictional interference between the platform 3 and the lower clasp portion 15. The vertical adjustment knob 10 can also be loosened to increase the distance a vertical between the platform 3 and the lower clasp portion 15.

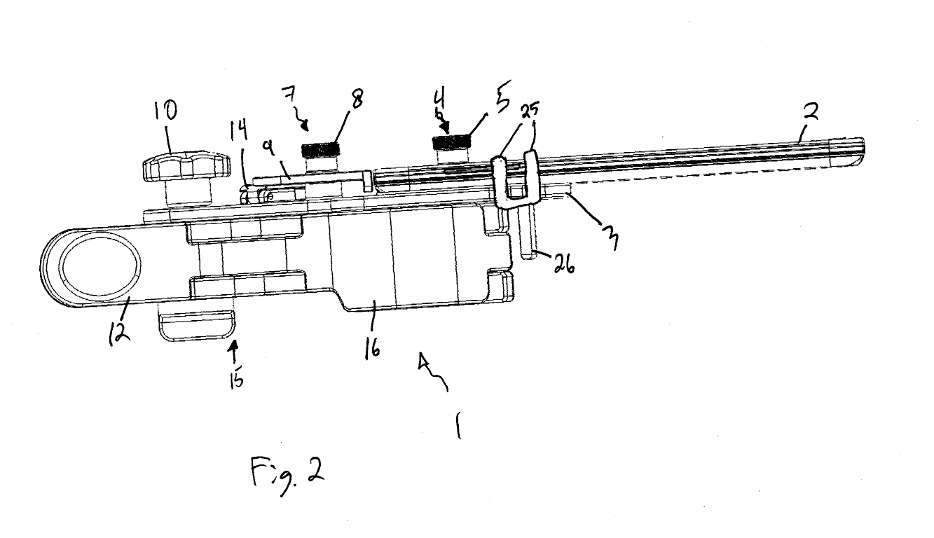

FIG. 2 is a side view of the adapter 1.

FIG. 3 is a perspective view of the bottom side of the adapter 1. As can be seen in FIG. 3, the platform 3 includes a hole 20. The hole 20 goes through the platform 3. As such, when the adaptor 1 is coupled to a barrel of a microscope, light passing through the eyepiece of the barrel of the microscope can pass through the hole 20 in the platform 1 and be received by a camera lens 30 of the camera device 2.

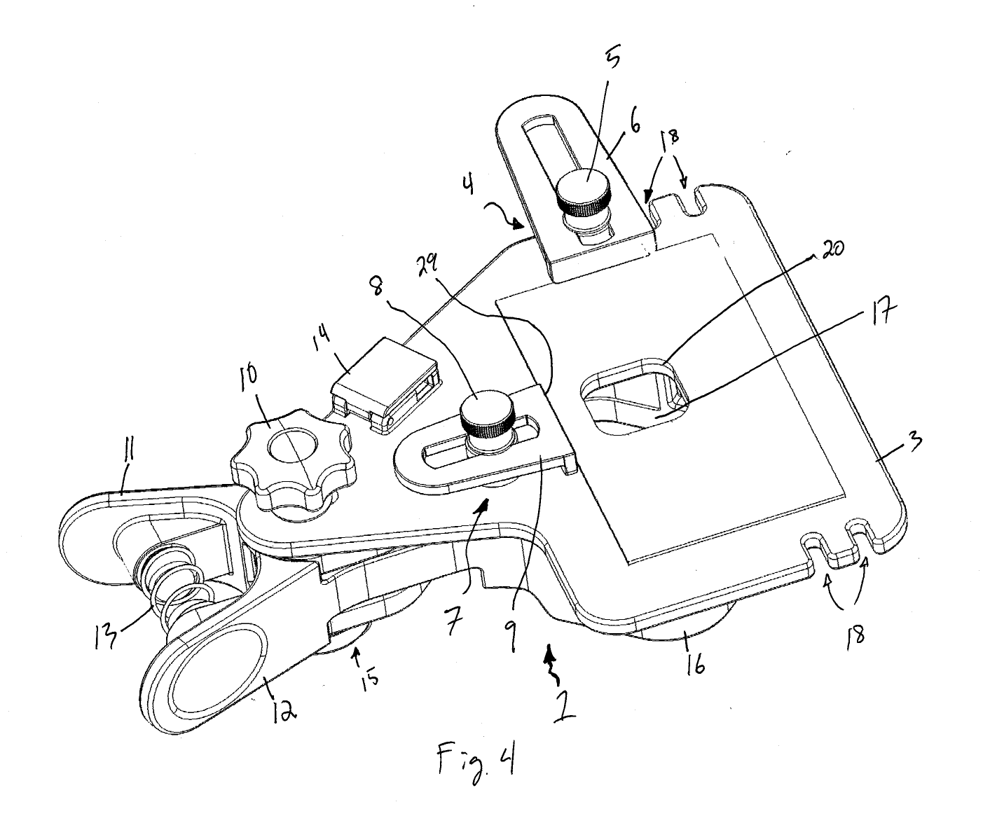

FIG. 4 is a perspective view of the adaptor 1 without the camera device 2. The topside of the hole 20 in the platform 3 can now be seen. As mentioned previously, the lateral adjustment mechanism 4 and the distal-proximal adjustment mechanism 7 are used to adjust the position of the camera device 2, and thereby the lens 30 of the camera device 2, over the hole 20 and in line with the barrel or the eyepiece of the barrel of the microscope.

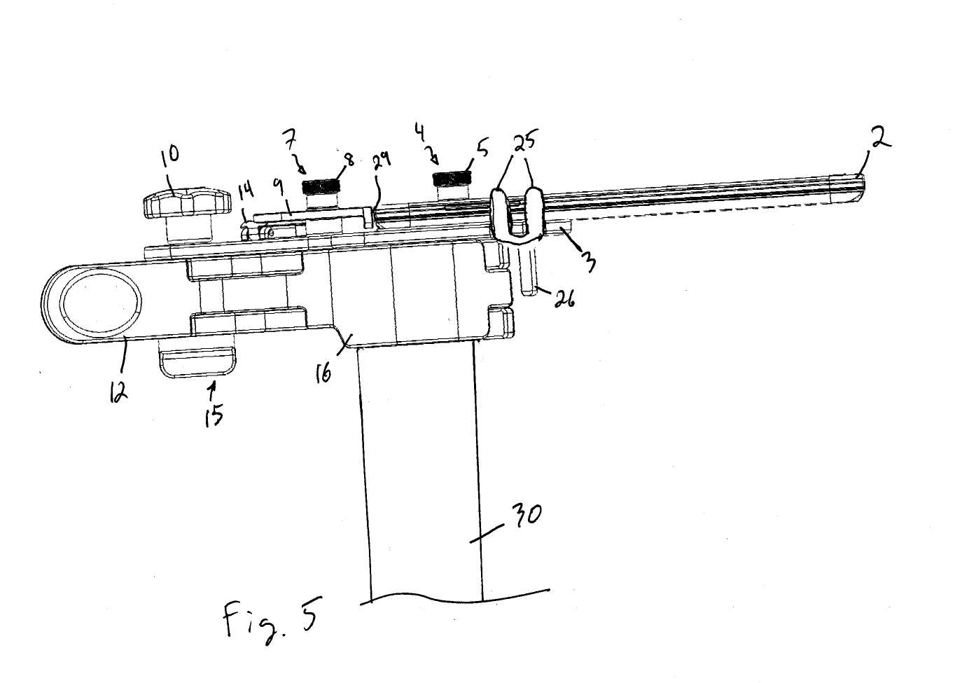

FIG. 5 is a side view of the adapter 1 mounted on the barrel 30 of a microscope. While the barrel 30 is shown, it will be understood that the adapter 1 can attach to various other parts of microscopes.

To actuate the lower clasp portion 15, a user squeezes the left proximal arm 11 and the right proximal arm 12 to compress the spring 13, which widens the distance between the right distal arm 16 and the left distal arm 17. As such, the right distal arm 16 and the left distal arm 17 can wrap around the barrel 30 of a microscope, as shown in FIG. 5. The adaptor 1 can be secured to the barrel 30 of the microscope by releasing the left proximal arm 11 and the right proximal arm 12 to allow the spring 13 to bias the right distal arm 15 towards the left distal arm 17, which results in the barrel 30 being clamped between the right distal arm 16 and the left distal arm 17. A flange 26, projecting downward from the platform 3, can help center the hole 20 over the barrel 30 or the eyepiece of the barrel 30 of the microscope.

The inner surfaces of the right distal arm 16 and the left distal arm 17 can be comprised of or be encased in a high friction material, such as rubber, in order to provide a more secure frictional attachment of the right distal arm 16 and the left distal arm 17 to the barrel30. Likewise, the topside of the platform 3can be comprised of or can be encased in a high friction material, such as rubber, to engage the camera device 2 and minimize the possibility of slippage between the camera device 2 and a platform 3.

The platform 3 can pivot about the vertical adjustment knob 10, relative to the lower clasp portion 15, to allow the lower clasp portion 15 to remain attached to the barrel 30 while a user looks through the barrel 30 of the microscope. The platform 3 can rotate about the vertical adjustment knob 10 to again align the hole 20 with the barrel 30 or the eyepiece of the barrel 30 of the microscope to continue taking images with the camera device 2.

The adapter 1 is a convenient universal mechanism to produce light artifact-minimized images using many cell phone cameras to light microscopes with oculars ranging from, for example, 20-50 mm in diameter. The adaptor is sized to fit in a white coat pocket. The adaptor 1 can be mounted and ready for use in seconds.

When a user has acquainted their smart phone to an adapter 1, an act that would require them to preset their lateral and distal-proximal settings, they can go from having the adapter 1 in their lab coat to attached to a microscope and taking stabilized, light-artifact free images in less than 3 seconds. The left proximal arm 11 and the right proximal arm 12 are used to squeeze the compression spring 13, increasing the distance between the right distal arm 16 and the left distal arm 17 to match the diameter of the barrel 30 of the microscope. A camera device 2 may then strapped to the platform 1 by the elastic band 25. In other embodiments, a camera device 2 may be strapped to the platform 1 by a clip or a clamp. Adjustments requiring an increase or decrease in height of the camera device 2 relative to the surface of the barrel 30 can be made using the vertical adjustment knob 20. In embodiments, the distance between the camera device 2 relative to the surface of the barrel 30 or the eyepiece of the barrel 30 can be adjustable between 0.0 mm (i.e., the camera lens of the camera device 2 is resting on the surface of the eyepiece of the barrel 30) to a distance between the bottom side of the platform 1 and a camera lens of a camera device 2 that is secured to the top side of the platform 1. In any of these distances, outside light will not be introduced into an image taken by the camera device 2. In other embodiments, however, the maximum height may be greater than a distance between the bottom side of the platform 1 and a camera lens of a camera that is secured to the top side of the platform 1.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. An adaptor for coupling a camera device to a microscope, the adaptor comprising:
a platform for releasably receiving a camera device, wherein the platform comprises a hole that can align with a lens of the camera device and a barrel of the microscope; and
a clasp portion for removably coupling the adaptor to the barrel of the microscope.

2. The adaptor of claim 1, wherein the adaptor further comprises an attachment structure that can releasably attach the camera device to the platform.

3. The adaptor of claim 2, wherein the attachment structure is at least one of the following: a clasp, a clamp and an elastic band.

4. The adaptor of claim 1, further comprising an adjustment mechanism operable to move the camera device relative to the hole and to a position where a camera lens of the camera device is aligned with the hole of the platform.

5. The adaptor of claim 4, wherein the adjustment mechanism comprises:
a first adjustment mechanism that can slide along a first axis relative to the hole and engage a first side of the camera device to position the camera device at a position along the first axis; and
a second adjustment mechanism that can slide along a second axis relative to the hole and engage a second side of the camera device to position the camera device at a position along the second axis, the second axis being substantially perpendicular to the first axis.

6. The adaptor of claim 5, wherein the first adjustment mechanism comprises a first structure that can secure the first adjustment mechanism at a position along the first axis and the second adjustment mechanism comprises a second structure that can secure the second adjustment mechanism at a position along the second axis.

7. The adaptor of claim 6, wherein the first structure and the second structure are at least one of the following: a knob and a clamp.

8. The adaptor of claim 1, wherein the clasp portion comprises: a first right arm and a first left arm that clasp onto the barrel of the microscope.

9. The adaptor of claim 8, wherein the first right arm comprises a rubber material at a point of contact between the first right arm and the barrel of the microscope and wherein the first left arm comprises a rubber material at a point of contact between the first left arm and the barrel of the microscope.

10. The adaptor of claim 8, further comprising a biasing structure coupled to the first right arm and the first left arm that provides a force that biases the first right arm and the first left arm toward each other.

11. The adaptor of claim 10, wherein the biasing structure is a spring.

12. The adaptor of claim 8, wherein the clasp portion further comprises: a second right arm, a second left arm and a spring mechanism located between the second right arm to the second left arm, the spring mechanism providing a force that biases the second right and the second left arm away from each other, which biases the first right arm and the first left arm toward each other.

13. The adaptor of claim 1, further comprising: a coupling structure, wherein the coupling structure couples the platform to the clasp, wherein the platform can rotate about the coupling structure to align the hole with the barrel of the microscope.

14. The adaptor of claim 13, wherein the coupling structure is an adjustment knob.

15. The adaptor of claim 1, wherein the platform is generally planar.

16. The adaptor of claim 1, further comprising a flange projecting from a bottomside of the platform for aligning the hole of the platform with the barrel of the microscope.

17. A method for operating an adaptor for coupling a camera device to a microscope, the method comprising:
placing a camera device on an adaptor, wherein the adaptor comprises a platform for releasably receiving the camera and a clasp portion, wherein the platform comprises a hole that can align with a lens of the camera device and a barrel of the microscope; and
releasably mounting the adaptor to the barrel of the microscope such that the hole of the platform is substantially aligned with the barrel of the microscope.

18. The method of claim 17, wherein the adaptor further comprises an attaching structure for releasably attaching the camera device to the platform and wherein placing the camera device on the adaptor comprises attaching the camera device to the platform using the attaching structure.

19. The method of claim 17, wherein the attaching structure is an elastic band that has a proximal end coupled to a first side of the platform and wherein attaching the camera device to the platform using the elastic band comprises stretching the elastic band over the camera device and coupling a distal end of the elastic band to a second side of the platform, the second side of the platform being opposite the first side of the platform.

20. The method of claim 17, wherein the adaptor further comprises an adjustment mechanism operable to move the camera device relative to the hole, the method further comprising:
moving the adjustment mechanism to a position that engages the camera and a camera lens of the camera device is aligned with the hole of the platform.

21. The method of claim 20, wherein the adjustment mechanism comprises a first adjustment mechanism that can slide along a first axis relative to the clasp portion and engage a first side of the camera device and a second adjustment mechanism that can slide along a second axis relative to the clasp portion and engage a second side of the camera device, the second axis being substantially perpendicular to the first axis and wherein moving the adjustment mechanism comprises:
sliding the first adjustment mechanism along the first axis such that the first adjustment mechanism engages the first side of the camera device at a first position, wherein a camera lens of the camera device is aligned with the hole along the first axis when the first side of the camera device is at the first position; and
sliding the second adjustment mechanism along the second axis such that the second adjustment mechanism engages the second side of the camera device at a second position, wherein a camera lens of the camera device is aligned with the hole along the second axis when the second side of the camera device is at the second position.

22. The method of claim 21, wherein the first adjustment mechanism comprises a first structure that secures the first adjustment mechanism at a position along the first axis and the second adjustment mechanism comprises a second structure that secures the second adjustment mechanism at a position along the second axis, the method further comprising:
securing the first adjustment mechanism, using the first structure, at the first position; and
securing the second adjustment mechanism, using the second structure, at the second position.

23. The method of claim 17, wherein the adaptor further comprises a coupling structure that couples the platform to the clasp, wherein the platform can rotate about the coupling structure to align the hole with the barrel of the microscope and wherein releasably mounting the adaptor to the barrel of the microscope comprises: rotating the platform about the coupling structure to align the hole of the platform with the barrel of the microscope.

24. The method of claim 17, further comprising:
taking a first image, using the camera device, of a section of a sample as viewed through the barrel of the microscope at a first time; and
taking a second image, using the camera device, of the section of the sample as viewed through the barrel of the microscope at a second time.

25. An adaptor for coupling a camera device to a microscope, the adaptor comprising:
a platform comprising:
a generally planar surface in an X-Y plane, a top side of the generally planar surface configured to receive the camera device, and
an aperture in the generally planar surface, the aperture configured to allow light to pass through the aperture and be received by a camera lens of the camera; and
a clasp portion coupled to a bottom side of the platform for removably coupling the adaptor to a barrel of the microscope.

26. The adaptor of claim 25, further comprising:
a first adjustment mechanism configured to slide along an axis in the X direction and engage a first side of the camera device to position the camera device at a first position along the X axis; and
a second adjustment mechanism configured to slide along an axis in the Y direction and engage a second side of the camera device to position the camera device at a second position along the Y axis.
